(19) United States
(12) Patent Application Publication
(10) Pub. No.: US 2002/0108244 A1
(43) Pub. Date: Aug. 15, 2002

(54) Punching tool for forming tube slots in a manifold of a heat exchanger

(76) Inventors: Stephane Appert, Prunay (FR); Herve Charlot, Thionville (FR); Serge Paris, Givonne (FR)

Correspondence Address: PATRICK M. GRIFFIN, DELPHI TECHNOLOGIES, INC., Legal Staff, Mail Code: 480-414-420, P.O. Box 5052, Troy, MI, 48007-5052, US

(21) Appl. No.: 10/060,917

(22) Filed: Jan. 29, 2002

(30) Foreign Application Priority Data
Feb. 12, 2001 (LU) 90728

(51) Int. Cl. B21D 53/02; B26F 1/14

(52) U.S. Cl. 29/890.03; 83/686

(57) ABSTRACT

A punching tool for forming elongated slots in a tubular wall comprises a punching end having a generally oblong cross section, said cross section comprising a central portion and two lateral portions. According to the invention, said central portion has a larger thickness than said lateral portions.

### TECHNICAL FIELD

The present invention generally relates to the manufacture of heat exchangers, for example, for use in motor vehicle air conditioning systems, and more specifically to a punching tool for forming tube slots in a manifold of a heat exchanger.

### BACKGROUND OF THE INVENTION

Motor vehicle heat exchangers usually comprise two header tanks or manifolds, which are aligned in a parallel arrangement, and flow tubes which extend in parallel between the two manifold tubes. Furthermore, fins are placed between the tubes for enhancing the heat transfer capacity of the flow tubes.

The flow tubes have a generally oblong section. In order to assemble the heat exchanger, the ends of the flow tubes are aligned, simultaneously inserted into corresponding oblong slots in the manifold tubes and thereafter brazed thereto. In order to be able to simultaneously insert a plurality of flow tubes into corresponding slots of the manifold tubes, a high accuracy of the shape of the slots is required.

The slots are formed in a punching operation, whereby a plurality of punching tools are simultaneously driven through the rounded wall of the manifold tube. During the punching operation, when a cutting edge of the punching tool is driven through the manifold tube material, the tube wall is deformed prior to being cut by said cutting edge. This deformation results in an inwardly rounded border of the slot, thus forming a flared lead-in for the flow tubes. Due to the rounded shape of the manifold tube, the deformation is much higher in the region of the centre of the slot than at the ends of the slots.

Some major suppliers of the automotive heat exchanger market are currently using punching tools, which have their faces contained in two parallel planes. It follows that the punching dies have a generally oblong cross section, comprising a flat centre portion and two rounded lateral portions. The problem observed in the slot shape after a lancing operation with these known punching tools is the hour-glassed shape of the slot resulting from material strength reaction. This results in a distorted shape compared to the theoretical oblong slot suitable for insertion of the flow tubes.

### SUMMARY OF THE INVENTION

The object of the present invention is to provide a punching tool which does not have the above described drawback.

The object is achieved by a punching tool for forming elongated slots in a tubular wall according to claim 1. The punching tool comprises a punching end having a generally oblong cross section, said cross section comprising a central portion and two lateral portions. According to the invention, said central portion has a larger thickness than said lateral portions.

During the punching operation with the present punching tool, the thicker centre portion of the tool widens the slot in the region of the centre. This mechanical widening of the slot compensates for the natural tube wall strength reaction so that the typical hour-glassed shape of the formed slot can be prevented. It follows that after the material reaction, the slot geometry is much closer to the theoretical oblong shape.

In a preferred embodiment, said cross section of said punching end has a rounded rhombic shape, that is, a rhombic shape with rounded corners. The gradually increasing thickness (when seen from the outside to the centre) is best suited to compensate for the deformation characteristic of a tubular manifold. It will be appreciated that the exact form of the cross section depends from the tube material, the tube diameter and the dimensions of the slot to be formed. If suitably designed, a punching tool having such a rhombic shape can effectively prevent any distortion of the slot form. It follows that with a punching tool of this kind, the slot geometry easily remains within a suitable tolerance range compatible with the insertion of the flow tubes and the brazing operation between the manifold and the flow tube.

The deformation of the tube wall during punching is highest in the centre portion and smallest in the outer lateral portions of the slot. It follows, that with a conventional punching tool, no natural flared lead-in for the flow tubes is formed in the lateral regions of the slot. In order to form a lead-in also in the lateral portions, a preferred embodiment of the punching tool comprises a deformation portion adjacent to said punching end, said deformation portion comprising deformation means for deforming said tubular wall at a border of said elongated slot. The deformation means is preferably located in those regions of the punching tool, in which the deformation of the tubular manifold wall is normally not sufficient in order to create a flared border. It follows that deformation means are preferably located at the two lateral portions of the punching tool. It should be noted that the deformation means could also surround said deformation portion on its entire periphery. In this case, the flared border can be specifically shaped on the entire periphery of the formed slot.

In a possible embodiment, said deformation means comprises an enlargement which extends outwardly of said lateral portion of said deformation portion. Due to this deformation means, a lead-in is also created at the lateral ends of the oblong slots, thus simplifying the insertion of the flow tubes. It will be appreciated that the presence of a lead-in on the entire periphery of the slot also enhances the brazing of the flow tubes on the manifold. In fact, by filling the space between the flared border and the inserted flow tube with brazing material, a secure and tight mounting can be easily achieved.

In order to ensure a smooth deformation of the border of the slot, said enlargement comprises advantageously a tapered section, said section tapering towards said punching end.

The form of the enlargements is preferably chosen so that there is a smooth transition between the flared lead-in at the lateral ends of the slot and the longitudinal lead-in. In a preferred embodiment, the enlargements have, for example, a generally elliptical cross section.

It has to be noted that the deformation means are preferably arranged in a retracted position with respect to a cutting edge of the punching tool. A favourable arrangement is such that the deformation means only enter the slot at the end of the lancing stroke, that is, the deformation of the border is only achieved immediately before the movement of the punching tool is reversed. If the punching tool is retracted, the punching tool and the border immediately separate, so that the flared border will not be damaged during retraction.

A leading edge of said punching end is usually designed as a cutting edge. The cutting edge preferably comprising two branches forming an angular recess or indent, said recess being symmetrical about a central axis of said punching tool. The so formed lancing angle is advantageously optimised for the diameter and the gauge of the tube.

### BRIEF DESCRIPTION OF THE DRAWINGS

The present invention will now be described, by way of example, with reference to the accompanying drawings, in which:

FIG. 1 is a cross section of an embodiment of a punching tool according to the present invention;

FIG. 2 is a side view of a punching tool;

FIG. 3 is a section of the tool along line A-A′; and

FIG. 4 is a cross section of the tool along line B-B′.

### DESCRIPTION OF THE PREFERRED EMBODIMENT

FIG. 2 represents a side vie of a preferred embodiment of a punching tool 10 according to the present invention. Punching tool 10 generally comprises a punching end 12, the leading edge of which is formed as a cutting edge 14.

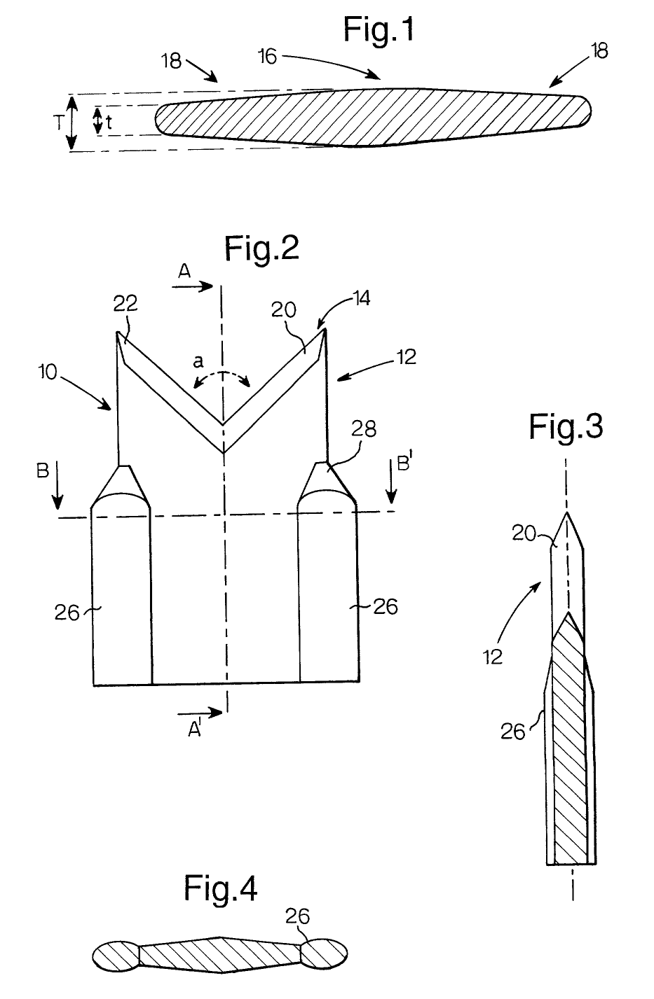

The punching end 12 of the punching tool 10 has preferably an oblong cross section, wherein a central portion 16 of said cross section has a larger thickness T than the thickness t of the lateral portions 18 (FIG. 1). In the embodiment shown in FIG. 1, said cross section has a rounded rhombic cross section, that is, a rhombic shape with rounded corners. The gradually increasing thickness (when seen from the outside to the centre) of such a rhombic shape is best suited to compensate for the deformation characteristic of a tubular manifold. It will be appreciated that the optimal ratio T/t of the rhombic shape depends from the tube material, the tube diameter, and the dimensions of the slot to be formed.

Referring again to FIG. 2, the cutting edge 14 comprises two adjacent branches 20 and 22, which form an angular recess or indent. The angle α between the two branches 20 and 22 is preferably optimised for the diameter and the gauge of the tube.

Adjacent the punching end 12, the punching tool 10 comprises a deformation portion 24 for forming a flared border at the lateral ends of the slot to be punched. In the deformation portion 24, one bulge 26 is laterally arranged on each lateral portion of the punching tool (see also FIG. 3). The function of this bulge is to deform the border of the punched hole into a flared lead-in especially at the two ends of the elongated slot. The shape of the bulges 26 is preferably optimised in order to provide a smooth transition between the flared lead-in at the lateral ends of the slot and the longitudinal lead-in. In the shown embodiment, the bulges 26 have a generally elliptical cross section (see FIG. 4).

Towards the punching end 12 of the punching tool, the bulges preferably comprise a section 28, tapering towards the punching end. This tapered section 28 ensures a smooth deformation of the border of the slot during the punching operation. It will be noted that the bulges 26 are preferably arranged in a retracted position with respect to a cutting edge 14 of the punching tool 10. A favourable arrangement is such that the deformation means only enter the slot at the end of the lancing stroke, that is, the deformation of the border is only achieved immediately before the movement of the punching tool is reversed. If the punching tool is retracted, the punching tool and the border immediately separate, so that the flared border will not be damaged during retraction.

1. Punching tool for forming elongated slots in a tubular wall, said punching tool comprising a punching end having a generally oblong cross section, said cross section comprising a central portion and two lateral portions, characterised in that said central portion has a larger thickness than said lateral portions.

2. Punching tool according to claim 1, wherein said cross section of said punching end has a rounded rhombic shape.

3. Punching tool according to claim 1 or claim 2, comprising a deformation portion adjacent to said punching end, said deformation portion comprising deformation means for deforming said tubular wall at a border of said elongate slot.

4. Punching tool according to claim 3, wherein said deformation means comprises an enlargement, said enlargement extending outwardly of said lateral portion of said deformation portion.

5. Punching tool according to claim 4, wherein said enlargement comprises a tapered section, said section tapering towards said punching end.

6. Punching tool according to claim 4 or claim 5, wherein said enlargement has a generally elliptical cross section.

7. Punching tool according to any one of the preceding claims, wherein a leading edge of said punching end is designed as a cutting edge, said cutting edge comprising two branches forming an angular recess, said recess being symmetrical about a central axis of said punching tool.

8. Use of a punching tool according to any one of the preceding claims for forming tube slots in a manifold of a heat exchanger.
